(19) United States
(12) Patent Application Publication
(10) Pub. No.: US 2013/0173851 A1
(43) Pub. Date: Jul. 4, 2013

(54) NON-VOLATILE STORAGE DEVICE, ACCESS CONTROL PROGRAM, AND STORAGE CONTROL METHOD

(71) Applicants: Toshio TANAKA, Yokohama-Shi (JP); Ryohei YAMAGUCHI, Fujisawa-Shi (JP)

(72) Inventors: Toshio TANAKA, Yokohama-Shi (JP); Ryohei YAMAGUCHI, Fujisawa-Shi (JP)

(73) Assignee: Kabushiki Kaisha Toshiba, Tokyo (JP)

(21) Appl. No.: 13/600,470

(22) Filed: Aug. 31, 2012

(30) Foreign Application Priority Data
Dec. 28, 2011 (JP) 2011-289195

(51) Int. Cl. G06F 12/02

(52) U.S. Cl. 711/103; 711/E12.008

(57) ABSTRACT

An access control program is executed by a specific electronic device first connected to the non-volatile storage device to associate with the specific electronic device to be given full access to the storage, executed by the specific electronic device to set the specific electronic device associated with the non-volatile storage device to a first mode permitting full access to the storage, executed by an arbitrary electronic device connected to the non-volatile storage device to judge whether the arbitrary electronic device is the specific electronic device associated with the non-volatile storage device by performing certification; and executed by the arbitrary electronic device connected to the non-volatile storage device to perform mode setting.

### CROSS REFERENCE TO RELATED APPLICATIONS

This application is based upon and claims the benefit of priority from the prior Japanese Patent Application No. 2011-289195, filed on Dec. 28, 2011, the entire contents of which are incorporated herein by reference.

### FIELD

Embodiments of the present invention relate to a non-volatile storage device, and an access control program and a storage control method for storing information in the non-volatile storage device.

### BACKGROUND

A non-volatile storage device using a flash memory, such as a memory card of various types and an SSD (Solid State Disk), has been rapidly spreading. The storage capacity of the non-volatile storage device has been increased year by year, and a non-volatile storage device having a storage capacity equivalent to that of HDD (Hard Disk Drive) is available in market.

The non-volatile storage device, which is smaller than HDD in external size and has strong resistance to physical impact, is often used to transfer data in a mobile environment. For example, a USB memory is useful for transferring data and generally used all over the world since various electronic devices including PCs have USB terminals.

The spread of the USB memory has caused a problem of copyright protection for data. A recent USB memory has a storage capacity equivalent to that of HDD, and it is extremely easy to illegally copy the entire confidential data from someone's PC to a USB memory. Actually, it has become more frequent that confidential data is illegally copied to a USB memory and taken outside.

Considering such circumstances, several techniques have been suggested to impose access restriction on a non-volatile storage device such as a USB memory.

In these techniques, access restriction is set using information (e.g., password) for identifying a specific user, and the user is required to input the identification information such as a password before using a non-volatile storage device, which is not convenient for the user. Further, once the password is leaked, any PC can freely use the non-volatile storage device, which does not ensure high information security performance.

### BRIEF DESCRIPTION OF THE DRAWINGS

FIG. 1 is a schematic diagram of a computer system having a non-volatile storage device 1 and computers 2.

FIG. 2 is a block diagram showing the internal structure of the non-volatile storage device 1 according to a first embodiment.

FIG. 3 is an operating mode transition diagram of an access control program 10 stored in a storage 3 in the non-volatile storage device 1 according to the first embodiment.

FIG. 4 is a diagram showing the storage area of the non-volatile storage device.

FIG. 5 is a flow chart showing an example of processing steps performed by an application program.

FIG. 6 is an operating mode transition diagram of the access control program 10 stored in the storage 3 in the non-volatile storage device 1 according to a second embodiment.

FIG. 7 is a block diagram showing the internal structure of the non-volatile storage device 1 according to a third embodiment.

FIG. 8 is an operating mode transition diagram of the access control program 10 stored in the storage 3 in the non-volatile storage device 1 according to the third embodiment.

FIG. 9 is a block diagram showing the internal structure of the non-volatile storage device 1 according to a fourth embodiment.

FIG. 10 is an operating mode transition diagram of the access control program 10 stored in the storage 3 in the non-volatile storage device 1 according to the fourth embodiment.

### DETAILED DESCRIPTION

According to one embodiment, a non-volatile storage device removably connected to an electronic device, has a storage capable of reading and writing data configured to store an access control program, the program being readable by the electronic device.

The program is executed by a specific electronic device first connected to the non-volatile storage device to associate with the specific electronic device to be given full access to the storage,

executed by the specific electronic device to set the specific electronic device associated with the non-volatile storage device to a first mode permitting full access to the storage,

executed by an arbitrary electronic device connected to the non-volatile storage device to judge whether the arbitrary electronic device is the specific electronic device associated with the non-volatile storage device by performing certification, and

executed by the arbitrary electronic device connected to the non-volatile storage device to perform mode setting so that the arbitrary electronic device connected to the non-volatile storage device is set to the first mode when the arbitrary electronic device is judged to be the specific electronic device based on the certification, or so that the arbitrary electronic device connected to the non-volatile storage device is set to a second mode restricting access to the storage when the arbitrary electronic device is not judged to be the specific electronic device based on the certification.

Every time the non-volatile storage device is connected to a new electronic device, the new electronic device being set to the first or second mode based on a result of the certification.

Embodiments of the present invention will now be explained referring to the drawings. In the following, explanation will be given on a non-volatile storage device removably connected to an electronic device such as a computer.

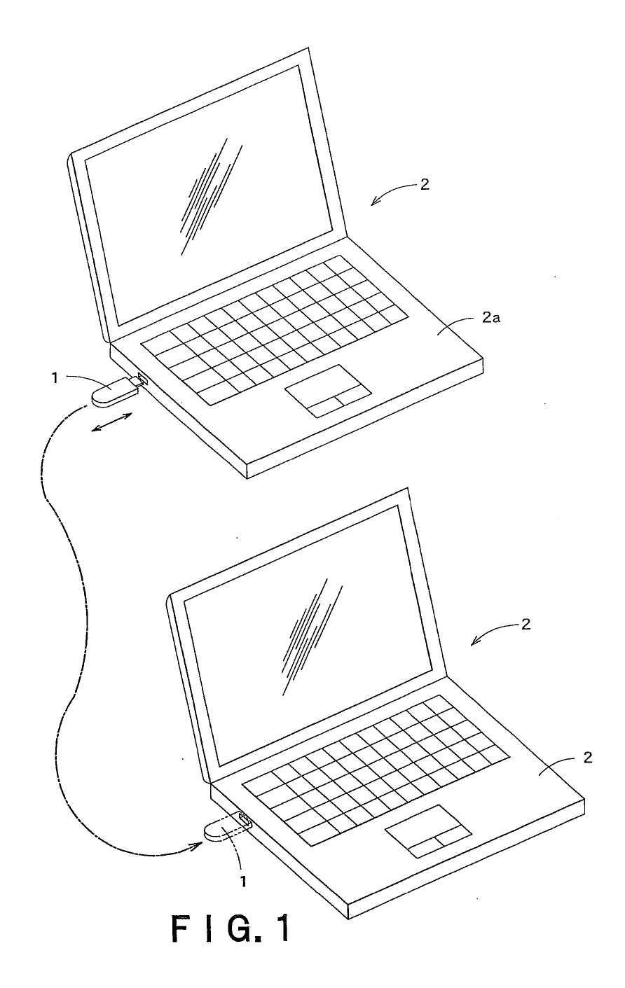

FIG. 1 is a schematic diagram of a computer system having a non-volatile storage device 1 and computers 2. In the example of FIG. 1, a USB memory 1 serving as an example of the non-volatile storage device 1 is connected to a USB terminal of the computer 2. In FIG. 1, the computer 2 connected to the USB memory 1 is an owner computer 2a, and the other computer is a visitor computer 2b. Although the number of owner computers 2a should be limited, the number of visitor computers 2b should not be limited.

As described later, when the non-volatile storage device 1 according to the present embodiments is connected to the owner computer 2a, an application program in the non-volatile storage device 1 is executed by the owner computer 2a, and the owner computer 2a is given full access to the non-volatile storage device 1.

Next, when the non-volatile storage device 1 is removed from the owner computer 2a and connected to the visitor computer 2b separate from the owner computer 2a, the visitor computer 2b can access the non-volatile storage device 1 only under a predetermined access restriction. Hereinafter, the mechanism of such access control will be explained in detail.

### First Embodiment

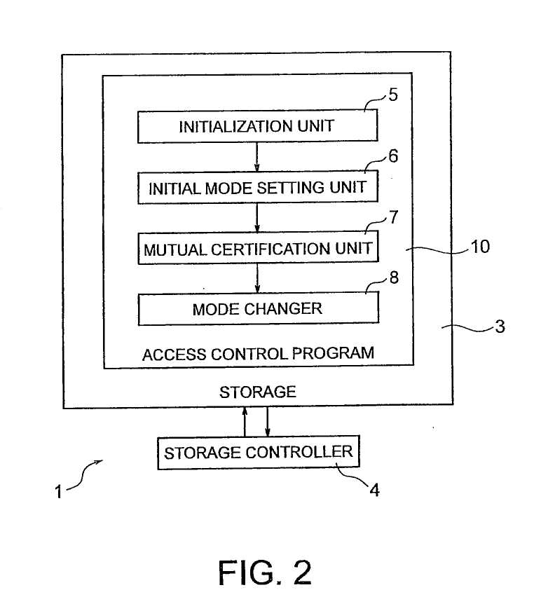

FIG. 2 is a block diagram showing the internal structure of the non-volatile storage device 1 according to a first embodiment. The non-volatile storage device 1 of FIG. 2 is, e.g., the USB memory 1 having a storage 3 and a storage controller 4. The storage 3 stores an application program to be executed by an arbitrary computer connected to the non-volatile storage device 1. This application program includes an access control program 10. When the non-volatile storage device 1 is connected to a computer, the access control program 10 is read and executed by the computer without a particular operation by the user of the computer.

As shown in FIG. 2, the access control program 10 includes an initialization unit 5, an initial mode setting unit 6, a mutual certification unit 7, and a mode changer 8. That is, the initialization unit 5, the initial mode setting unit 6, the mutual certification unit 7, and the mode changer 8 are realized by software.

The storage 3 is, e.g., a readable/writable memory cell array, which is typically used in a NAND-type flash memory. Certainly, it is also possible to use another type of non-volatile semiconductor memory such as MRAM, ReRAM, etc. The storage controller 4 performs control for storing information in the storage 3.

The initialization unit 5 associates (connects) the non-volatile storage device 1 with the owner computer 2a to be given full access. Here, the association is performed, e.g., by registering information (e.g., device ID) for uniquely identifying the owner computer 2a in the management area of the non-volatile storage device 1.

The initial mode setting unit 6 sets the associated owner computer 2a to a first mode. Here, the first mode is a mode permitting full access to the entire storage area of the storage 3 in the non-volatile storage device 1. When the non-volatile storage device 1 is connected to the owner computer 2a set to the first mode, the owner computer 2a can freely read/write information from/in the non-volatile storage device 1.

The mutual certification unit 7 judges whether the computer connected to the non-volatile storage device 1 of FIG. 2 is the owner computer 2a associated with the non-volatile storage device 1 by the initialization unit 5. This judgment process is performed each time the non-volatile storage device 1 of FIG. 2 is connected to an arbitrary computer. The mutual certification unit 7 performs mutual certification to confirm whether the identification information of the computer connected to the non-volatile storage device 1 corresponds to the identification information of the owner computer 2a registered in the non-volatile storage device 1 by the initialization unit 5.

The mutual certification is automatically performed by the mutual certification unit 7 just after the non-volatile storage device 1 is connected to an arbitrary computer. Therefore, the user can use the non-volatile storage device 1 without having particular consciousness. When the user unconsciously connects the non-volatile storage device 1 to the visitor computer 2b, the access to the device 1 is restricted and the user becomes aware of the access restriction.

The mode changer 8 performs mode setting based on the judgment result obtained by the mutual certification unit 7. More concretely, when the mutual certification unit 7 determines that the computer connected to the non-volatile storage device 1 of FIG. 2 is the owner computer 2a, the computer is set to the first mode, or when the mutual certification unit 7 determines that the computer is not the owner computer 2a, the computer is set to a second mode. The second mode is a mode imposing some access restriction on the non-volatile storage device 1.

As stated above, each time the non-volatile storage device 1 of FIG. 2 is connected to an arbitrary computer, the mode changer 8 sets this computer to the first mode or to the second mode based on the result of mutual certification performed by the mutual certification unit 7.

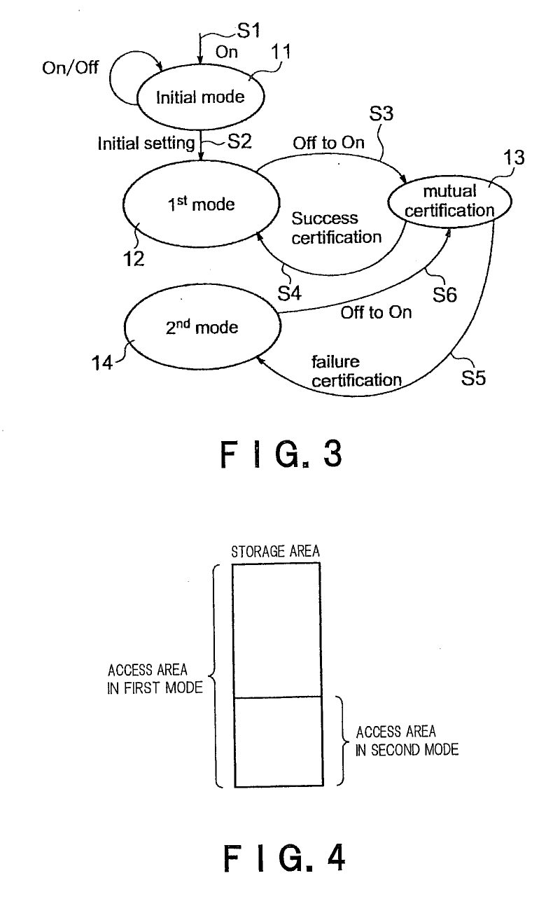

FIG. 3 is an operating mode transition diagram of the access control program 10 stored in the storage 3 in the non-volatile storage device 1 according to the first embodiment. As shown in FIG. 3, the access control program 10 has the following four operating modes, i.e. an initial mode 11, a first mode 12, a mutual certification mode 13, and a second mode 14.

The initial mode 11 is set when the non-volatile storage device 1 of FIG. 3 is first connected to any computer (Step S1). In the initial mode 11, the computer first connected to the non-volatile storage device 1 is determined as the owner computer 2a. This process is performed by the initialization unit 5.

As stated above, one of the characteristics of the present embodiment is that any computer can be used as the owner computer 2a. This improves the convenience of the user.

When the process by the initialization unit 5 is completed, the initial mode 11 automatically transits to the first mode 12 (Step S2). As stated above, in the first mode 12, the owner computer 2a has full access to the non-volatile storage device 1.

In the first mode 12, if the non-volatile storage device 1 is removed from the owner computer 2a and newly connected to an arbitrary computer including the owner computer 2a, the first mode 12 automatically transits to the mutual certification mode 13 (Step S3).

In the mutual certification mode 13, the mutual certification unit 7 shown in FIG. 2 judges whether the computer connected to the non-volatile storage device 1 is the owner computer 2a. Then, the mode changer 8 operates so that the computer connected to the non-volatile storage device 1 transits to the first mode 12 when the connected computer is the owner computer 2a (Step S4), or so that the computer connected to the non-volatile storage device 1 transits to the second mode 14 when the connected computer is not the owner computer 2a (Step S5).

The transition to the second mode 14 shows that the non-volatile storage device 1 is judged to have been connected to the visitor computer 2b. The visitor computer 2b has access restriction to the non-volatile storage device 1. The access restriction may be set in various ways, and FIG. 4 shows an example of permitting access only to a partial storage area of the non-volatile storage device 1.

As stated above, the mutual certification mode 13 transits to the first mode 12 when the non-volatile storage device 1 is judged to have been connected to the owner computer 2a, or transits to the second mode 14 when the non-volatile storage device 1 is judged to have been connected to the visitor computer 2b. That is, the first mode 12 is an operating mode for the owner computer 2a, while the second mode 14 is an operating mode for the visitor computer 2b.

In the second mode 14, if the non-volatile storage device 1 is removed from the visitor computer 2b and connected to an arbitrary computer including the visitor computer 2b, the second mode 14 transits to the mutual certification mode 13 again to judge whether the computer connected to the non-volatile storage device 1 is the owner computer 2a or the visitor computer 2b (Step S6).

The transition of the operating mode of the non-volatile storage device 1 as shown in FIG. 3 is controlled by the access control program 10 previously stored in the non-volatile storage device 1.

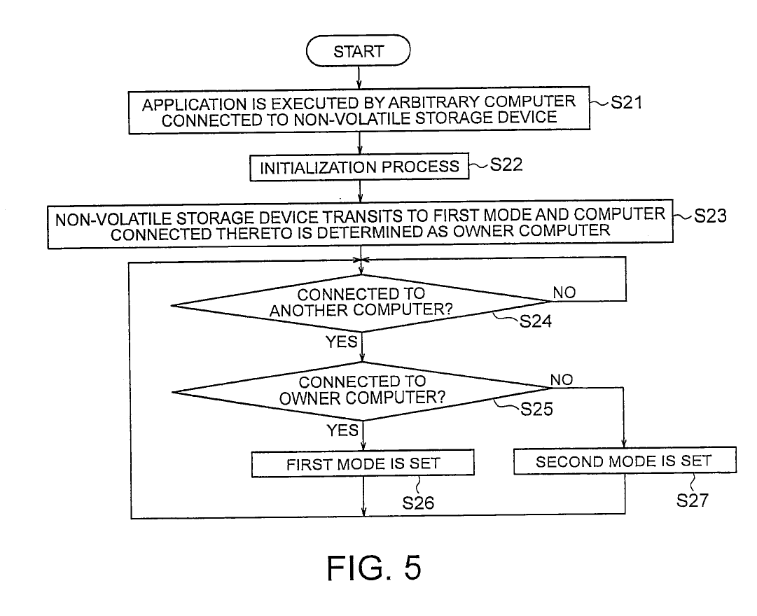

FIG. 5 is a flow chart showing an example of processing steps performed by the access control program 10. When the non-volatile storage device 1 according to the present embodiment is connected to an arbitrary computer, this computer starts to read and execute the access control program 10 previously stored in the non-volatile storage device 1 (Step S21). This program is executed each time the non-volatile storage device 1 is connected to a computer, regardless of the type of the computer.

This program is executed to detect whether the initialization unit 5 has completed the initialization process, and if not, the initialization process is performed (Step S22). By performing the initialization process, the non-volatile storage device 1 automatically transits to the first mode 12, and the computer connected to the non-volatile storage device 1 is determined as the owner computer 2a (Step S23).

After that, it is judged whether the non-volatile storage device 1 has been removed from the connected computer and connected to another computer (Step S24). If NO at Step S24, the flow remains at Step S24 until the result becomes YES, and if YES, the non-volatile storage device 1 is set to the mutual certification mode 13 to let the mutual certification unit 7 judge whether the computer newly connected to the non-volatile storage device 1 is the owner computer 2a (Step S25).

When the mutual certification is successful, that is, when the computer newly connected is the owner computer 2a, the non-volatile storage device 1 is set to the first mode 12 (Step S26), while when the computer newly connected is the visitor computer 2b, the non-volatile storage device 1 is set to the second mode 14 (Step S27). When the process of Step S25 or S26 is completed, the processing returns to Step S24.

As stated above, in the present embodiment, any arbitrary computer can be used as the owner computer 2a. More specifically, the computer connected to the non-volatile storage device 1 first becomes the owner computer 2a. Therefore, only by connecting the non-volatile storage device 1 to a computer with which the user wants to use the non-volatile storage device 1, the computer automatically becomes the owner computer 2a, which makes it possible for the user to have full access to the non-volatile storage device 1 using the computer without paying particular attention.

Further, when the user removes the non-volatile storage device 1 from the owner computer 2a and connects it to another computer, access restriction is automatically imposed on the non-volatile storage device 1. Accordingly, even when the non-volatile storage device 1 is fraudulently taken out by a third party, the third party is restricted from copying and moving the information stored in the non-volatile storage device 1. Therefore, it is possible to prevent the non-volatile storage device 1 from being abused while improving security performance, even if the user does not have particular consciousness.

### Second Embodiment

The first embodiment is characterized in that the visitor computer 2b is allowed to use the non-volatile storage device 1 under a predetermined access restriction, while a second embodiment explained below is characterized in that access to the non-volatile storage device 1 by the visitor computer 2b is restricted more severely.

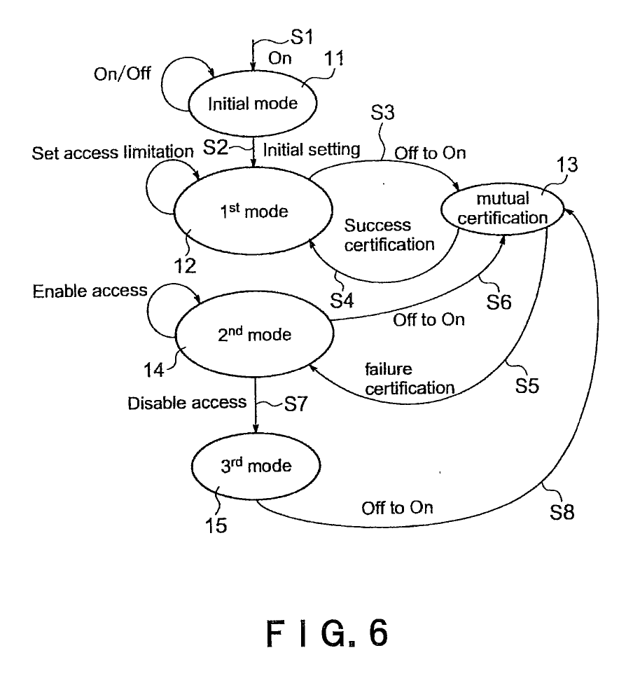

FIG. 6 is an operating mode transition diagram of the access control program 10 stored in the storage 3 in the non-volatile storage device 1 according to the second embodiment. In addition to the operating modes shown in the transition diagram of FIG. 3, the transition diagram of FIG. 6 further has a third mode 15. The third mode 15 is a mode to be transited when a predetermined condition is met in the second mode 14 (Step S7).

There are three types of access restrictions set in the second mode 14, i.e. 1) completely prohibiting any access to the non-volatile storage device 1, 2) permitting access to the non-volatile storage device 1 restrictively until the number of access reaches a predetermined value, but completely prohibiting any access to the non-volatile storage device 1 when the number of access reaches the predetermined value, and 3) permitting access to the non-volatile storage device 1 restrictively regardless of the number of access. Here, permitting restrictive access means allowing access only to a partial storage area of the non-volatile storage device 1.

In the case of 1) and when the number of access reaches a predetermined value in the case of 2), the second mode 14 transits to the third mode 15. That is, the third mode 15 is a mode completely prohibiting access to the non-volatile storage device 1. Therefore, in the third mode 15, the user cannot browse even a storage area which can be browsed in the second mode 14, and the user cannot confirm what files are stored in the non-volatile storage device 1 at all.

In the case of 1), the second mode 14 having transited from the mutual certification mode 13 immediately transits to the third mode 15 (Step S7). In the case of 2), the second mode 14 having transited from the mutual certification mode 13 transits to the third mode 15 as soon as the number of access to the non-volatile storage device 1 reaches a predetermined number of access. After the second mode 14 has transited to the third mode 15, if the non-volatile storage device 1 is removed once and connected to an arbitrary computer, the third mode 15 transits to the mutual certification mode 13 again (Step S8).

It is arbitrary which of the above conditions 1) to 3) should be adopted as the access restriction, and the setting may be changed by the application.

As stated above, in the second embodiment, when the non-volatile storage device 1 is connected to the visitor computer 2b, access to the non-volatile storage device 1 is restricted more severely based on the number of access, which makes it possible to prevent the illegal use of the non-volatile storage device 1 more surely.

Further, it is possible to intentionally loosen the access restriction while the number of access is small to allow the access by the user temporarily and exceptionally, which improves the convenience of the user.

### Third Embodiment

A third embodiment is characterized in that the owner computer 2a given full access to the non-volatile storage device 1 can be changed.

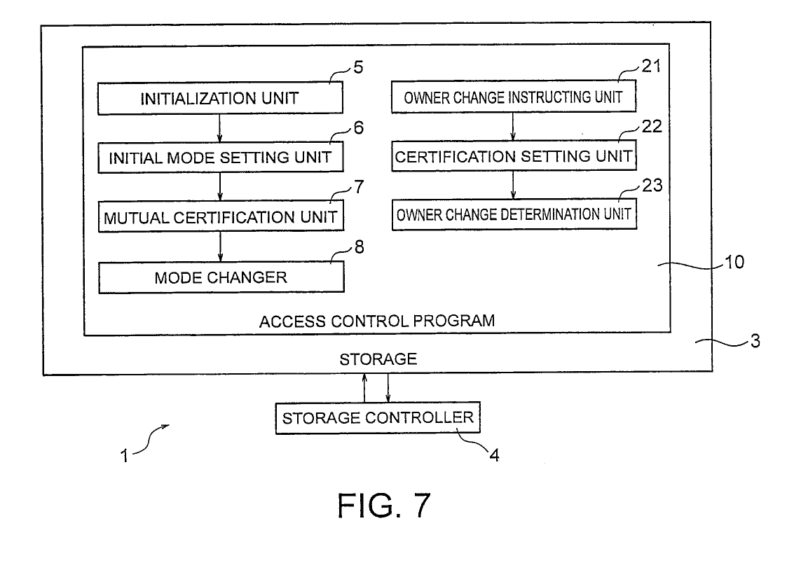

FIG. 7 is a block diagram showing the internal structure of the non-volatile storage device 1 according to the third embodiment. The non-volatile storage device 1 of FIG. 7 is different from the access control program 10 of FIG. 2 in the access control program 10 stored in the storage 3. In addition to the components of the access control program 10 of FIG. 2, the access control program 10 of FIG. 7 further has an owner change instructing unit 21, a certification setting unit 22, and an owner change determination unit 23. When the non-volatile storage device 1 is connected to a computer, the access control program 10 of FIG. 7 is read and executed by the computer without forcing the user of the computer to perform special operation.

The owner change instructing unit 21 makes the owner computer 2a transit to a fourth mode in order to change the owner computer 2a originally associated with the non-volatile storage device 1 by the initialization unit 5 to another computer. The fourth mode is a mode set for the original owner computer 2a when changing the owner computer 2a given full access to the non-volatile storage device 1 to another computer.

The certification setting unit 22 sets, on the owner computer 2a which has transited to the fourth mode, certification information (e.g., password) for performing certification using another computer.

A certification information checker checks the certification information set by the certification setting unit 22 when the connection target is changed from the owner computer 2a which has transited to the fourth mode to a new computer.

The owner change determination unit 23 changes the new computer to the owner computer 2a and sets it to the first mode 12 when the check by the certification information checker has been successful, or keeps the original owner computer 2a set to the first mode 12 without changing the new computer to the owner computer 2a when the check by the certification information checker has not been successful.

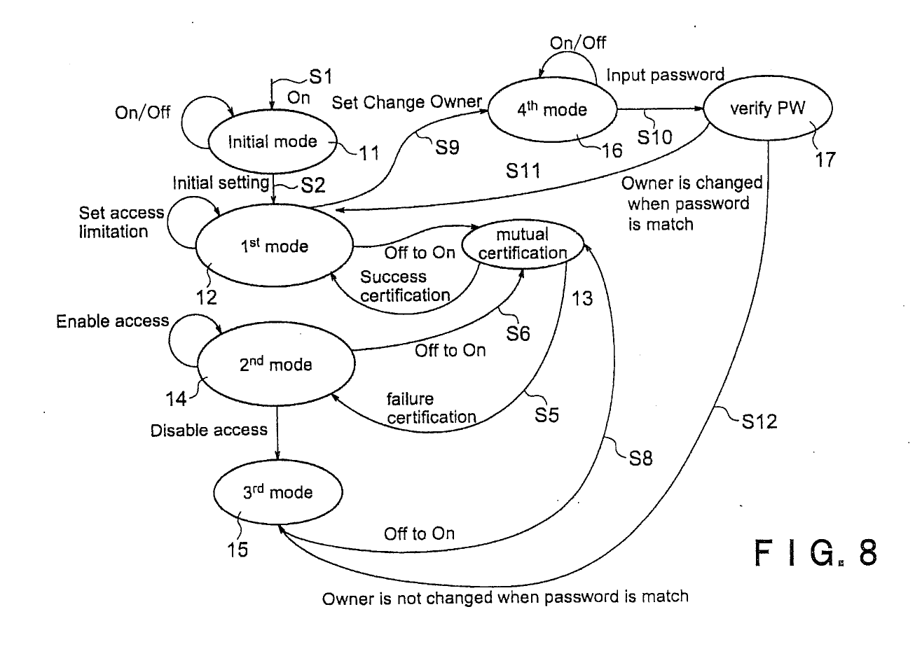

FIG. 8 is an operating mode transition diagram of the access control program 10 stored in the storage 3 in the non-volatile storage device 1 according to the third embodiment. In addition to the operating modes shown in the transition diagram of FIG. 6, the transition diagram of FIG. 8 further has a fourth mode 16 and a verify PW mode 17. When the user starts the access control program 10 on the owner computer 2a and the owner change instructing unit 21 instructs to change the owner computer 2a, the owner computer 2a transits to the fourth mode 16 (Step S9). In the fourth mode 16, the access control program 10 requests the user to input a password. This password is used to perform certification on another computer to be newly used as the owner computer 2a.

After that, when the user removes the non-volatile storage device 1 from the original owner computer 2a and connects it to another computer, the certification setting unit 22 requests the user to input the password for certification (Step S10). When the user inputs the password in response to this request, the fourth mode 16 transits to the verify PW mode 17 and the certification information checker performs certification. When the certification is successful, the computer currently connected is newly determined as the owner computer 2a, and set to the first mode 12 (Step S11). In this case, the original owner computer 2a becomes the visitor computer 2b having access restriction to the non-volatile storage device 1.

On the other hand, when the certification has not been successful, the computer currently connected is set to the third mode 15 (Step S12). Therefore, this computer is completely prohibited from accessing the non-volatile storage device 1. When the certification has not been successful, the original owner computer 2a is continuously set to the first mode 12 and given full access to the non-volatile storage device 1.

As stated above, in the third embodiment, the owner computer 2a can be changed to another computer, which overcomes a problem that access to the non-volatile storage device 1 is restricted when the user replaces the user's old PC with a new PC. Further, in order to prevent the owner computer 2a from being maliciously changed by a third party, the fourth mode 16 is newly arranged to perform the certification process before changing the owner computer 2a, which makes it possible to improve security performance.

### Fourth Embodiment

A fourth embodiment is characterized in that the visitor computer 2b is temporarily given full access to the non-volatile storage device 1.

As a situation where a non-volatile storage device such as the non-volatile storage device 1 is utilized, there is a case where the user of the non-volatile storage device 1 connects the non-volatile storage device 1 to a someone's PC in order to make a presentation or a printed material utilizing the files stored in the non-volatile storage device 1, or to copy and move the files between the someone's PC and the non-volatile storage device 1.

If the user cannot freely read, copy, and move files due to restriction, usability is remarkably deteriorated. Accordingly, the fourth embodiment explained below is characterized in that deterioration in usability can be prevented by temporarily allowing the visitor computer 2b to have full access.

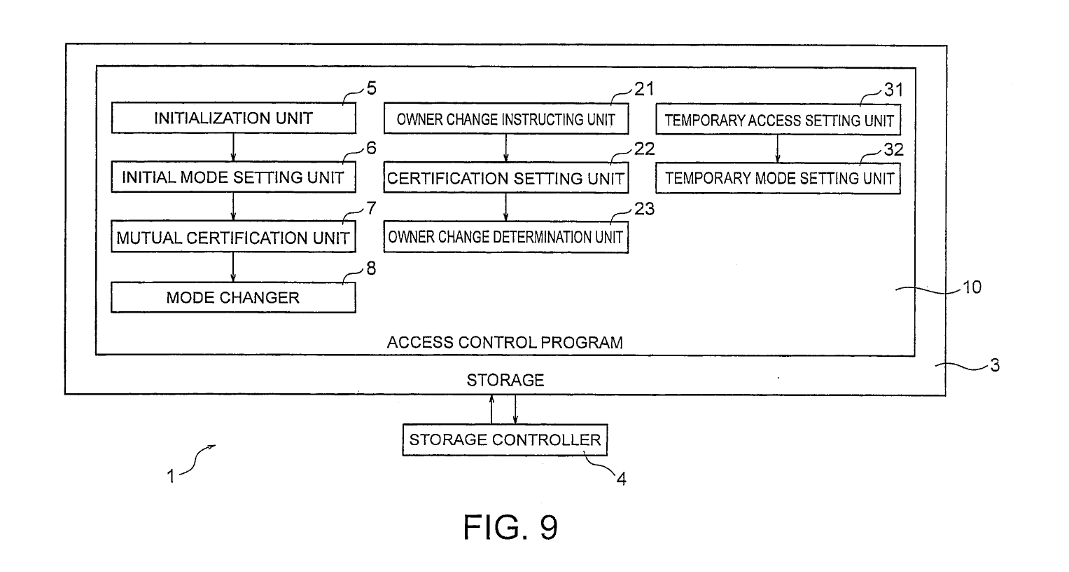

FIG. 9 is a block diagram showing the internal structure of the non-volatile storage device 1 according to the fourth embodiment. The non-volatile storage device 1 of FIG. 9 is different from the access control program 10 of FIG. 7 in the access control program 10 stored in the storage 3. In addition to the components of the access control program 10 of FIG. 7, the access control program 10 of FIG. 9 further has a temporary access setting unit 31 and a temporary mode setting unit 32. When the non-volatile storage device 1 is connected to a computer, the access control program 10 of FIG. 9 is read and executed by the computer without forcing the user of the computer to perform special operation.

The temporary access setting unit 31 performs setting, on a specific computer set to the first mode 12, to temporarily allow another computer to have full access to the storage 3. The temporary mode setting unit 32 sets a temporary mode for another computer connected to the non-volatile storage device 1 after the setting by the temporary access setting unit 31, the temporary mode allowing full access only while the connection is being kept.

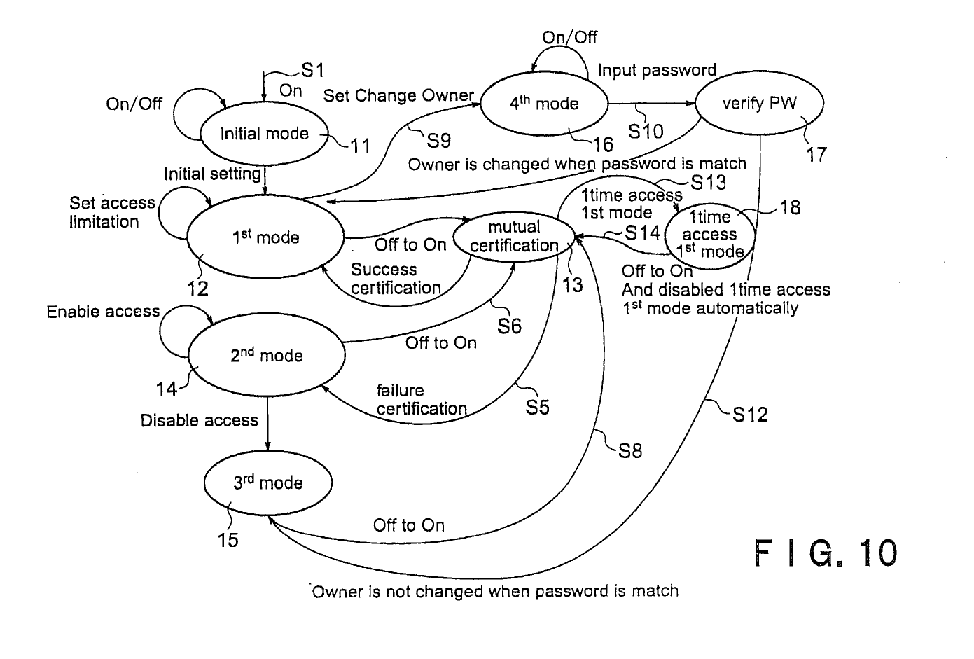

FIG. 10 is an operating mode transition diagram of the access control program 10 stored in the storage 3 in the non-volatile storage device 1 according to the fourth embodiment. In addition to the operating modes shown in the transition diagram of FIG. 8, the transition diagram of FIG. 10 further has a temporary mode 18 for temporarily allowing the visitor computer 2b to have full access to the non-volatile storage device 1. It is premised that the temporary mode 18 is set when the user starts the access control program 10 on the owner computer 2a and the temporary access setting unit 31 performs setting to temporarily allow the visitor computer 2b to have full access to the storage 3 (Step S13).

When the user completes the above setting and connects the non-volatile storage device 1 to the visitor computer 2b, the visitor computer 2b is set to the temporary mode 18 and allowed to have full access to the non-volatile storage device 1 until the non-volatile storage device 1 is removed from the computer. When the non-volatile storage device 1 is removed from the visitor computer 2b, the temporary mode 18 is cancelled and transits to the mutual certification mode 13 again (Step S14), and even when the non-volatile storage device 1 is connected to the same visitor computer 2b again, the visitor computer 2b cannot have full access or browse the data stored for a temporary full access period.

As stated above, the temporary mode 18 is effective only when the non-volatile storage device 1 is first connected to the visitor computer 2b. Once the connection is cut off, the temporary mode 18 is cancelled.

FIG. 10 is created by adding the temporary mode 18 to the transition diagram of FIG. 8, but the temporary mode 18 may be added to each of the transition diagrams of FIGS. 3 and 6.

As stated above, in the fourth embodiment, when the non-volatile storage device 1 is set to the temporary mode 18 on the owner computer 2a, only the visitor computer 2b first connected to the non-volatile storage device 1 after the setting is permitted to have full access to the non-volatile storage device 1, which makes it possible to restrict illegal access to the non-volatile storage device 1 while improving the convenience of the user.

### ANOTHER MODIFICATION EXAMPLE

The non-volatile storage device 1 in each of the above embodiments should not be limited to the USB memory 1, and any storage device can be used as long as it has a readable/writable non-volatile storage 3. For example, memory card of various types, SSD, HDD, optical disk device, magnetic optical disk device, etc. can be used as the non-volatile storage device 1.

In the examples explained in the above embodiments, the non-volatile storage device 1 is connected to a computer, but the electronic device connected to the non-volatile storage device 1 should not be necessarily limited to a computer. Any electronic device can be used as long as it is an electronic device having the same terminal (e.g., USB terminal) as the non-volatile storage device 1. For example, DVD recorder, BD recorder, HDD recorder, set-top box, etc. can be used instead of the computer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A non-volatile storage device removably connected to an electronic device, comprising a storage capable of reading and writing data configured to store an access control program, the program being readable by the electronic device,
wherein the program comprises:
being executed by a specific electronic device first connected to the non-volatile storage device to associate with the specific electronic device to be given full access to the storage;
being executed by the specific electronic device to set the specific electronic device associated with the non-volatile storage device to a first mode permitting full access to the storage;
being executed by an arbitrary electronic device connected to the non-volatile storage device to judge whether the arbitrary electronic device is the specific electronic device associated with the non-volatile storage device by performing certification; and
being executed by the arbitrary electronic device connected to the non-volatile storage device to perform mode setting so that the arbitrary electronic device connected to the non-volatile storage device is set to the first mode when the arbitrary electronic device is judged to be the specific electronic device based on the certification, or so that the arbitrary electronic device connected to the non-volatile storage device is set to a second mode restricting access to the storage when the arbitrary electronic device is not judged to be the specific electronic device based on the certification,
every time the non-volatile storage device is connected to a new electronic device, the new electronic device being set to the first or second mode based on a result of the certification.

2. The non-volatile storage device of claim 1,
wherein upon performing the mode setting, a third mode completely prohibiting access to the storage is set when a predetermined condition is met in the second mode.

3. The non-volatile storage device of claim 2,
wherein the second mode is a mode for permitting access only to a partial storage area in the storage, and
the predetermined condition shows a case where number of access to the partial storage area exceeds a predetermined number.

4. The non-volatile storage device of claim 2,
wherein the second mode is a mode for prohibiting access to an entire storage area of the storage, and
upon performing the mode setting, the arbitrary electronic device which is not judged to be the specific electronic device based on the certification is unconditionally transited from the second code to the third mode.

5. The non-volatile storage device of claim 1,
wherein the access control program comprises:
setting the specific electronic device associated with the non-volatile storage device to a fourth mode in order to change the specific electronic device to another electronic device;
setting, on the specific electronic device set to the fourth mode, certification information for performing certification using the another electronic device;
checking certification information inputted by a user with the set certification information when the non-volatile storage device is connected to a new electronic device after setting the certification information; and
changing an electronic device to be set to the first mode from the specific electronic device to the new electronic device when the check is successful, or keeping the specific electronic device set to the first mode without allowing the new electronic device to be set to the first mode when the check is not successful.

6. The non-volatile storage device of claim 1,
wherein the access control program comprises:
performing setting, on the specific electronic device set to the first mode, to temporarily allow another electronic device to have full access to the storage; and
setting a temporary mode for the another electronic device connected to the non-volatile storage device after performing the setting for allowing the temporary full access, the temporary mode allowing full access to the storage only while the connection is being kept.

7. A recording medium storing an access control program which is stored in a storage capable of reading and writing data in a non-volatile storage device removably connected to an electronic device, the program being executable by an electronic device connected to the non-volatile storage device,
wherein the access control program comprises:
being executed by a specific electronic device first connected to the non-volatile storage device to associate with the specific electronic device to be given full access to the storage;
being executed by the specific electronic device to set the specific electronic device associated with the non-volatile storage device to a first mode permitting full access to the storage;
being executed by an arbitrary electronic device connected to the non-volatile storage device to judge whether the arbitrary electronic device is the specific electronic device associated with the non-volatile storage device by performing certification; and
being executed by the arbitrary electronic device connected to the non-volatile storage device to perform mode setting so that the arbitrary electronic device connected to the non-volatile storage device is set to the first mode when the arbitrary electronic device is judged to be the specific electronic device based on the certification, or so that the arbitrary electronic device connected to the non-volatile storage device is set to a second mode restricting access to the storage when the arbitrary electronic device is not judged to be the specific electronic device based on the certification,
every time the non-volatile storage device is connected to a new electronic device, the new electronic device being set to the first or second mode based on a result of the certification.

8. The recording medium of claim 7,
wherein upon performing the mode setting, a third mode completely prohibiting access to the storage is set when a predetermined condition is met in the second mode.

9. The recording medium of claim 8,
wherein the second mode is a mode for permitting access only to a partial storage area in the storage, and
the predetermined condition shows a case where number of access to the partial storage area exceeds a predetermined number.

10. The recording medium of claim 8,
wherein the second mode is a mode for prohibiting access to an entire storage area of the storage, and
upon performing the mode setting, the arbitrary electronic device which is not judged to be the specific electronic device based on the certification is unconditionally transited from the second code to the third mode.

11. The recording medium of claim 7,
wherein the access control program comprises:
setting the specific electronic device associated with the non-volatile storage device to a fourth mode in order to change the specific electronic device to another electronic device;
setting, on the specific electronic device set to the fourth mode, certification information for performing certification using the another electronic device;
checking certification information inputted by a user with the set certification information when the non-volatile storage device is connected to a new electronic device after setting the certification information; and
changing an electronic device to be set to the first mode from the specific electronic device to the new electronic device when the check is successful, or keeping the specific electronic device set to the first mode without allowing the new electronic device to be set to the first mode when the check is not successful.

12. The recording medium of claim 7,
wherein the access control program comprises:
performing setting, on the specific electronic device set to the first mode, to temporarily allow another electronic device to have full access to the storage; and
setting a temporary mode for the another electronic device connected to the non-volatile storage device after performing the setting for allowing the temporary full access, the temporary mode allowing full access to the storage only while the connection is being kept.

13. The recording medium of claim 7,
wherein the non-volatile storage device is a USB memory.

14. A storage control method using a non-volatile storage device having a storage capable of reading and writing data, the storage being removably connected to an electronic device, comprising:
being executed by a specific electronic device first connected to the non-volatile storage device to associate with the specific electronic device to be given full access to the storage;
being executed by the specific electronic device to set the specific electronic device associated with the non-volatile storage device to a first mode permitting full access to the storage;
being executed by an arbitrary electronic device connected to the non-volatile storage device to judge whether the arbitrary electronic device is the specific electronic device associated with the non-volatile storage device by performing certification; and
being executed by the arbitrary electronic device connected to the non-volatile storage device to perform mode setting so that the arbitrary electronic device connected to the non-volatile storage device is set to the first mode when the arbitrary electronic device is judged to be the specific electronic device based on the certification, or so that the arbitrary electronic device connected to the non-volatile storage device is set to a second mode restricting access to the storage when the arbitrary electronic device is not judged to be the specific electronic device based on the certification,
every time the non-volatile storage device is connected to a new electronic device, the new electronic device being set to the first or second mode based on a result of the certification.

15. The storage control method of claim 14,
wherein upon performing the mode setting, a third mode completely prohibiting access to the storage is set when a predetermined condition is met in the second mode.

16. The storage control method of claim 15,
wherein the second mode is a mode for permitting access only to a partial storage area in the storage, and
the predetermined condition shows a case where number of access to the partial storage area exceeds a predetermined number.

17. The storage control method of claim 15,
wherein the second mode is a mode for prohibiting access to an entire storage area of the storage, and
upon performing the mode setting, the arbitrary electronic device which is not judged to be the specific electronic device based on the certification is unconditionally transited from the second code to the third mode.

18. The storage control method of claim 14,
wherein the access control program comprises:
setting the specific electronic device associated with the non-volatile storage device to a fourth mode in order to change the specific electronic device to another electronic device;
setting, on the specific electronic device set to the fourth mode, certification information for performing certification using the another electronic device;
checking certification information inputted by a user with the set certification information when the non-volatile storage device is connected to a new electronic device after setting the certification information; and
changing an electronic device to be set to the first mode from the specific electronic device to the new electronic device when the check is successful, or keeping the specific electronic device set to the first mode without allowing the new electronic device to be set to the first mode when the check is not successful.

19. The storage control method of claim 14
wherein the access control program comprises:
performing setting, on the specific electronic device set to the first mode, to temporarily allow another electronic device to have full access to the storage; and
setting a temporary mode for the another electronic device connected to the non-volatile storage device after performing the setting for allowing the temporary full access, the temporary mode allowing full access to the storage only while the connection is being kept.

20. The storage control method of claim 14
wherein the non-volatile storage device is a USB memory.
